(19) United States
(12) Patent Application Publication
(10) Pub. No.: US 2026/0115681 A1
(43) Pub. Date: Apr. 30, 2026

(54) Rotating Disc Effluent Reactor

(71) Applicant: Bruce Freeman, Lincoln, CA (US)

(72) Inventor: Bruce Freeman, Lincoln, CA (US)

(21) Appl. No.: 19/433,746

(22) Filed: Dec. 27, 2025

Related U.S. Application Data
(60) Provisional application No. 63/739,464, filed on Dec. 27, 2024.

(51) Int. Cl. B01J 19/18; B01J 12/00; B01J 19/00

(52) U.S. Cl. CPC B01J 19/18; B01J 12/007; B01J 19/0013; B01J 2219/00132; B01J 2219/182

(57) ABSTRACT

Rotating disk reactors, and methods of using such reactors, are described herein. The rotating disk reactors herein have a housing defining a cylindrical interior volume, the housing having at least one inlet and one gas outlet; a plurality of disks disposed within the housing with uniform spacing, each disk having a central axis aligned with a central axis of the interior volume, and each disk having a condition that can be used to stimulate a chemical reaction in a gas proximate to a surface of the disk; a rotor disposed along the central axis, and through a center, of at least some of the disks, the rotor extending outside the interior volume; and a motor located outside the interior volume and coupled to the rotor to rotate the rotor and the disks.

### CROSS REFERENCE TO RELATED APPLICATIONS

This application claims priority to U.S. Provisional Patent Application No. 63/739,464 filed on Dec. 27, 2025.”]

This application is related to U.S. Pat. No. 3,996,012, issued Dec. 7, 1976, to Friedrich J. Zucker, entitled “Catalytic reactor having disk-shaped, rotor-stator reaction surfaces.”

This application is related to Korean Patent No. 10-0961765, issued Jun. 7, 2010, to Lee Jeong-seok et al., entitled “Spinning disc reactor.”

This application is related to U.S. Pat. No. 10,689,275, issued Jun. 23, 2020, to Katherine Huddersman et al., entitled “Rotating contactor reactor.”

This application is related to U.S. Pat. No. 7,115,235, issued Oct. 3, 2006, to Colin Ramshaw et al., entitled “Rotating surface of revolution reactor with temperature control mechanisms.”

This application is related to International Patent Publication No. WO 2000/048730 A2, published Aug. 24, 2000, to Colin Ramshaw et al., entitled “Rotating surface of revolution reactor with shearing mechanisms.”

### FIELD OF THE INVENTION

This application for patent relates to chemical reactors. The chemical reactors described herein use rotating disks that have a reaction stimulating condition.

### BACKGROUND OF THE INVENTION

Chemical reactors are in common use for performing reactions in gas phase materials. It is usually desired to perform reactions requiring high energy input using reactors that are as efficient as possible in translating energy input into reaction conversion. New, more efficient, gas phase chemical reactors are always in demand for performing reactions such as remediation of species that cannot be directly released to the environment, preparation of useful small molecules, and chemical activation for a manufacturing process.

### SUMMARY OF THE INVENTION

Embodiments described herein provide an apparatus, comprising a housing defining a cylindrical interior volume, the housing having at least one inlet and one gas outlet; a plurality of disks disposed within the housing with uniform spacing, each disk having a central axis aligned with a central axis of the interior volume, and each disk having a condition that can be used to stimulate a chemical reaction in a gas proximate to a surface of the disk; a rotor disposed along the central axis, and through a center, of at least some of the disks, the rotor extending outside the interior volume; and a motor located outside the interior volume and coupled to the rotor to rotate the rotor and the disks.

### BRIEF DESCRIPTION OF THE DRAWINGS

FIG. 1 is a cross-sectional view of a rotating disk reactor according to one embodiment.

FIG. 2A is a cross-sectional view of a rotating disk reactor according to another embodiment.

FIG. 2B is a schematic partial cross-sectional view of a rotating disk reactor according to another embodiment.

FIG. 3A is a detail view of a schematic cross-section of a reactor according to another embodiment.

FIG. 3B is a plan view of a plate that can be used to make rotating disks for the reactors described herein according to one embodiment.

FIGS. 4A, 4B, and 4D are oblique views of embodiments of disks that can be used in any of the rotating disk reactors described herein.

FIG. 4C is a schematic cross-section of a portion of a disk, according to one embodiment, that can be used in any of the rotating disk reactors described herein.

FIG. 4E is a plan view of a disk that can be used in a rotating disk reactor like those described herein.

FIG. 4F is a plan view of a portion of a disk that can be used in a rotating disk reactor like those described herein

FIG. 5 is a cross-sectional view of a rotating disk reactor according to another embodiment.

FIG. 6 is a schematic cross-sectional view of a rotating disk reactor 600 according to another embodiment.

FIG. 7A is a schematic cross-sectional view of a rotating disk reactor according to another embodiment.

FIG. 7B is a detail view of a portion of the cross-section of FIG. 7A.

### DETAILED DESCRIPTION OF THE INVENTION

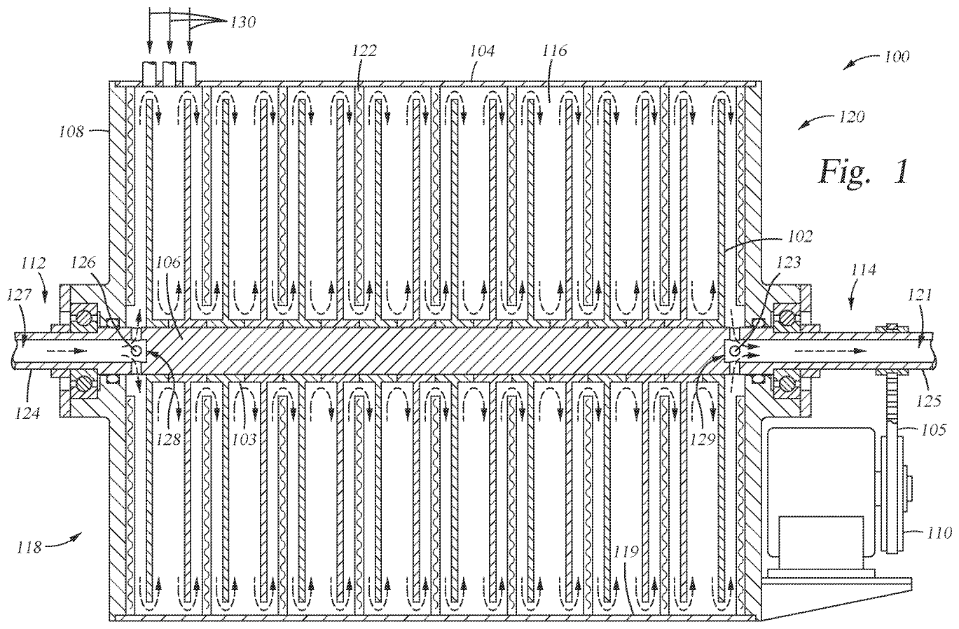

This application for patent describes and claims chemical reactors that use rotating disks to stimulate fluid flow through a reaction chamber. The rotating disks have a condition that can be used to stimulate a chemical reaction in the fluid as it flows in proximity to the disks. FIG. 1 is a cross-sectional view of a rotating disk reactor 100 according to one embodiment. The reactor 100 has a plurality of disks 102 disposed within a housing 104. At least some of the disks 102 are coupled to a rotor 106 that extends within the housing 104 and through a wall 108 of the housing 104 to couple with a motor 110 exterior to the housing 104. Each disk 102 has a coupling 103, in this case a flange, that can be attached, optionally removably attached, for example bolted or adhered, to the rotor 106. The housing 104 has at least one inlet 112 and one outlet 114, each disposed through the wall 108 for charging materials to the reactor 100 and withdrawing materials from the reactor 100. The motor 110 is disposed at a location spaced apart from the central axis of the reactor 100, and is coupled to the rotor 106 by a drive coupling 105, which may be a belt or other suitable member.

In operation, the disks 102 are rotated within the housing 104, by turning the rotor 106, to stimulate flow of gases within an interior 116 of the housing 104. Gases are provided at the inlet 112 of the housing 104, flow within the housing according to paths influenced by interaction with the rotating disks 102, and are withdrawn from the housing at the outlet 114. The housing 104, in this case, has a cylindrical profile, so the interior 116, wherein the disks 102 are disposed, has a substantially cylindrical shape. In this case, the inlet 112 is located at a first end 118 of the housing 104 at or near a central axis of the housing 104 and the outlet 114 is located at a second end 120 of the housing 104, opposite from the first end 118, also near the central axis of the housing 104.

At least some of the disks 102, in some cases all of the disks 102, have a condition that can, or that can be used to, stimulate a chemical reaction in gases that come into proximity or contact with the disks 102 while flowing through the housing The condition can be a capability to absorb energy from an energy unit and emit thermal energy to heat gases proximate to, or contacting, the disks 102. Thus, in such cases, at least some of the disks 102 are made of a material that is selected to efficiently absorb energy from an energy unit that is configured to provide an energy that can be efficiently absorbed by the disks 102. The material of the disks 102 may also be selected to provide the capability to efficiently emit thermal energy. The condition may be an electromagnetic condition that creates electromagnetic fields, such as RF or microwave fields, as the disks 102 are rotated, that can ionize gases proximate to, or in contact with, the disks 102. The condition may be a condition of chemical potential, such as a catalytic material, that can activate a chemical reaction among gases proximate to, or in contact with, the disks 102. One disk may have a combination of such conditions. Among the plurality of disks 102, a first subset of the disks 102 may have a first condition for stimulating a chemical reaction while a second subset of the disks 102, different from the first subset, has a second condition for stimulating a chemical reaction. Thus, in one embodiment, a chemical reactor such as the reactor 100 may have a first plurality of disks 102 that are used for heating a gas flowing through the housing 104 while a second plurality of disks 102 comprises a catalytic material.

The housing 104 has an interior surface 119 that is configured to interact with the rotating disks 102 to encourage a desired fluid flow through the housing 104. Generally, the interior surface 119 is configured to confine the disks 102 to a small volume, and thus the interior 116 has a volume selected to optimize fluid flow across the disks 102 and to promote intimate interaction of flowing fluids with the disks 102. Clearance between the edges of the disks 102 and the interior surface 119 is 0.01 to 0.5%, for example about 0.25%, of the diameter of the disks 102 in many cases. Thus, in an embodiment that uses disks having diameter of 200 mm, the clearance between the edges of the disks and the interior surface of the housing may be about 0.5 mm.

The disks 102 can have uniform spacing or non-uniform spacing, depending on the desired gas flow pattern. In some cases, the number of disks 102 used in a single reactor is maximized to provide maximum reactive stimulus to gases within the reactor. Typically, gas flow within the reactor is optimal where boundary layer flow and friction is used to maximum effect. Thus, disk spacing that provides just enough room for full boundary layer development and interaction is typically used. Boundary layer thickness depends on parameters of interaction between gases flowing within the housing and the material of the disks, operating pressure, and dimension and rotation speed of the disks. Such interactions are known, so disk spacing can be selected based on expected boundary layer conditions during operation of the reactor 100. In many cases, a reactor such as the reactor 100 may use disks of diameter approximately 200 mm (or alternately 6 inches) rotating at a rate of 10,000 rpm, and gas flow at an operating pressure of 10-300 Torr, to develop boundary layer thickness of about 1 mm, so in such cases disk spacing of 2.5 mm might be selected to provide a desired operational efficiency. Where gases are to be ionized by interacting with the disks, lower pressures can be useful, and where gases are to be treated using a catalyst, higher pressures, for example sub-atmospheric, atmospheric, or above atmospheric pressures, can be useful. In general, larger disk spacing reduces interaction between gas and disk surfaces, but may encourage more interaction between gas and disk surfaces near the center of the disks by allowing more gas flow to the center of the disks near the rotor. In general, smaller disk spacing has the opposite effect. Where disk spacing is so small that boundary layer flow is disrupted or constrained, efficiency of interaction between gases and disk surfaces can be diminished. In such cases, adding flow guide features to the disks can moderate some effects of small disk spacing.

The chemical reactor 100 has a plurality of inductive sources 122 positioned to apply thermal energy to the disks 102. In this case, an inductive source 122 is disposed between the two disks of each neighboring pair of disks 102. Thus, in the case of FIG. 1, an inductive source 122 is disposed in every other space between disks 102. As the disks 102 are rotated, the disks 102 absorb energy from the inductive field created by each inductive source 122. Each inductive source 122 has an inductive circuit that creates an inductive field extending into the material of the disks 102 to cause heating of the material of the disks 102. In this case, each inductive source 122 is attached to the wall 108 of the housing 104 at the interior surface 119 thereof. Power supply for the electric circuits of each inductive source 122 can be wiring (not shown) routed through the wall 108 or through a conduit (not shown) routed along the wall 108 outside the housing 104. The disks absorb energy from the inductive fields, and convert the inductive energy into thermal energy within the disks 102, which builds up within the disks 102 such that the temperature of each disk 102 rises. As the temperature of the disks 102 rises, the disks emit thermal energy according to the Stefan-Boltzmann Law, thus heating gas proximate to the surface of the disks 102.

The inductive sources 122, in this case, are planar in aspect and extend from the wall 108 of the housing 104 radially inward toward the rotor 106 between two neighboring disks 102. These inductive sources 122 are disk-shaped, each inductive source 122 contacting the wall 108 along the entire periphery of the inductive source 122. As an inductive source, disk-shaped structure houses a circuit in an interior thereof that creates the inductive field. In a disk-shaped structure, the circuit can spiral around the interior of the disk-shaped structure, winding around multiple cycles of a 360 degree azimuthal extent. Alternately, the circuit can extend azimuthally around part of the 360 degree extent, and can extend back and forth in various ways. The inductive sources 122 could be discrete bodies representing part of a disk, with gaps between inductive sources 122 disposed at the same axial location. Many different configurations can be used and envisioned.

In other cases where thermal energy is to be used, the energy applied to the disks can be applied in other electromagnetic forms. Radiant energy, for example, can be used in many different ways. Heat lamps can generally heat the interior of the housing 104, also heating the disks 102 themselves. Radiation can be specifically directed to the disks 102, rather than generally heating the interior 116 of the housing 104. For example, radiation sources such as laser bars and LED bars can be disposed within the interior 116 to direct radiant energy to the surfaces of one or more of the disks 102. Thus, the inductive sources 122 of FIG. 1 could also be radiant sources of any suitable variety, such as laser or LED sources. The radiation used can be selected based on absorption characteristics of the disk material to make heating the disks 102 using radiant energy as efficient as possible. Lasers and LEDs emitting in the red and near-lR range, for example, can be used to heat silicon efficiently. Emission in the UV range can heat glass. Where disks 102 are made of a transmissive material, such as glass, radiant beam emissions can be configured to interact with the disks at the edges thereof to enter the material of the disk with minimal reflection and propagate through the material to accomplish heating within the material through internal reflection.

The disks 102 are generally thin to minimize the energy needed to rotate the disks 102. The disks 102 may have thickness that is less than the spacing between neighboring disks. The disks 102 may have thickness between 0.3 mm and 2.5 mm in some cases. For some applications, disks resembling semiconductor wafers can be used, although the materials used for the disks 102 can be more diverse. In some cases, the disks 102 may be made of silicon or silicon carbide, or may be silicon that is coated with silicon carbide, silicon nitride, silicon oxide or other glass or ceramic material. In other cases, the disks 102 can be made of a suitable metal, such as tungsten or zirconium, for example a metal that can be efficiently heated but that resists chemical attack. Where a catalytic material is used, the catalytic material may be coated onto the disk. For example, in one case a thin layer of platinum, perhaps 10 μm thick, can be coated onto a disk to catalyze a chemical reaction within a gas that responds to platinum. Other catalytic metals, such as palladium, ruthenium, cobalt, rhenium, rhodium, and the like, can also be used. Where a metal catalyst is to be coated onto the disk, the disk itself may be made or,
or previously coated with, a catalyst support material such as alumina, titania, zirconia, zeolites (i.e. metal aluminosilicates), activated carbon, clay, polymer, or other catalyst support material. Such coatings can be formed using well-known methods.

As noted above, one disk may use a combination of conditions to stimulate chemical reactions. For example, a first portion of the disk may be coated with a catalytic material while a second portion of the disk is uncoated and subjected to heating. In such cases, as the disks are rotated and gas flows across the rotating disks, reactive zones may develop where different chemical reactions proceed. Thus, a disk may support an outer reaction zone that performs a first reaction or reaction type and an inner reaction zone that performs a second reaction or reaction type. As reactions occur, such effects can change gas flow characteristics at locations along the disk as reaction fronts propagate. For example, a reaction in an outer zone may cause a pressure increase within the gas boundary layer flowing across the disk such that the boundary layer grows in thickness as gas flows across the disk surface. Such effects can be compensated and/or optimized by controlling a temperature of the disk in one or more zones and by controlling gas flow rate and pressure within the housing 104.

The rotating disks 102 generally encourage gas to flow between the disks 102 and substantially spread across the disk surfaces between the disks 102, which can be controlled by operating pressure within the housing. At higher pressures, more gas will flow between the disks 102. The disks generally operate according to the fluid flow principles of a Tesla turbine, and use those flow principles to obtain chemical reactions from interaction of the gas with the disks 102. Thus, as noted above, utilizing the general flow patterns within the housing 104, reaction zones can be configured to perform different reactions at different radial and axial locations with the housing 104.

In some cases, the chemical reactor 100 can be operated to ionize gases within the housing. The disks 102 can be heated to an ionizing temperature and/or the disks 102 can include the capability to produce electromagnetic fields that ionize gases. For example, the disks 102 can have a magnetic condition that, when the disks are rotated, create an electromagnetic field similar to RF or microwave radiation to ionize gases proximate to the disks. Permanently magnetic material can be embedded in the outer surface of the disk, or may be disposed through the thickness of the disk, exposed at both opposing surfaces of the disk, or may be just coated onto the disk surface. Combinations of such structures can also be used. As noted above, combinations of all the conditions described above can also be used.

In the reactor 100 of FIG. 1, the rotor 106 is solid. The inlet 112 is disposed along the central axis of the reactor 100 through a gas coupling 124 disposed through the wall 108 of the housing 104. The gas coupling 124 has a plurality of ports 126 at a distal end 128 thereof that provide fluid communication from a conduit 127 of the gas coupling 124 to the interior 116 along the interior surface 119 at the first end 118. In this case, the gas coupling 124 is a hollow section of the rotor 106 sf the meter that couples to the solid section of rotor 106 within the interior 116. Gas flows through the conduit 127 of the gas coupling 124, through the hollow section of the rotor meter 11Q, and out through the ports 126 of the gas coupling 124 into the interior 116 along the interior surface 119 at the first end 118 between the interior surface 119 and a surface of one rotating disk 102. The rotating disk 102 then influences flow of the gas into the rest of the interior 116 to interact with all the rotating disks 102 and exit the housing 104 at the outlet 114. Flow pressure, or gas flow rate, at the inlet 112 can be adjusted to ensure adequate residence time and interaction between the gas and the disks 102.

The gas coupling 124 is a first gas coupling at the inlet 112 of the housing A second gas coupling 125 is provided at the outlet 114 of the housing 104 to evacuate gas from the reactor 100. Like the first gas coupling 124, the second gas coupling 125 has a plurality of openings 123 at a distal end 129 thereof to admit gas from the interior 116 into a conduit 121 of the second gas coupling 125 to exit the reactor 100. The second gas coupling 125 may be connected to the rotor 106 to rotate with the rotor 106, or the second gas coupling 125 may be non-rotating.

The reactor 100 of FIG. 1 has a plurality of ports 130 for providing co-reactants to the interior 116 of the housing 104 to react with gas provided at the inlet 112 under the influence of the rotating disks 102. While a plurality of ports 130 are shown in FIG. 1, other versions could have only one port 130, or no ports 130. The co-reactants can be materials intended to transform the gas provided at the inlet 112 into a gas that can be released to the environment. Gas such as oxygen, hydrogen, and water are examples of such gases. In other cases, gases can be provided through the ports 130 to react with gases provided at the inlet 112 to form a product to be recovered at the outlet 114 for a particular use. The ports 130, here, are located at a side of the housing 104 to provide gases to the interior 116 of the housing at the periphery thereof. Here, the location of the ports 130 is between the first end 118 and a first inductive source 122 of the reactor 100 proximate to the first end 118. These ports 130 are azimuthally co-located (i.e. located at the same azimuthal location, angle, or coordinate) with small axial spacing adequate to locate the ports 130 between the first end 118 and the first inductive source 122. The location of the ports 130, in this case, is to provide suitable residence time for all reactants to achieve maximum conversion. Depending on the reactions intended, and the characteristics of those reactions, the ports 130 could be located at any suitable azimuthal and axial locations.

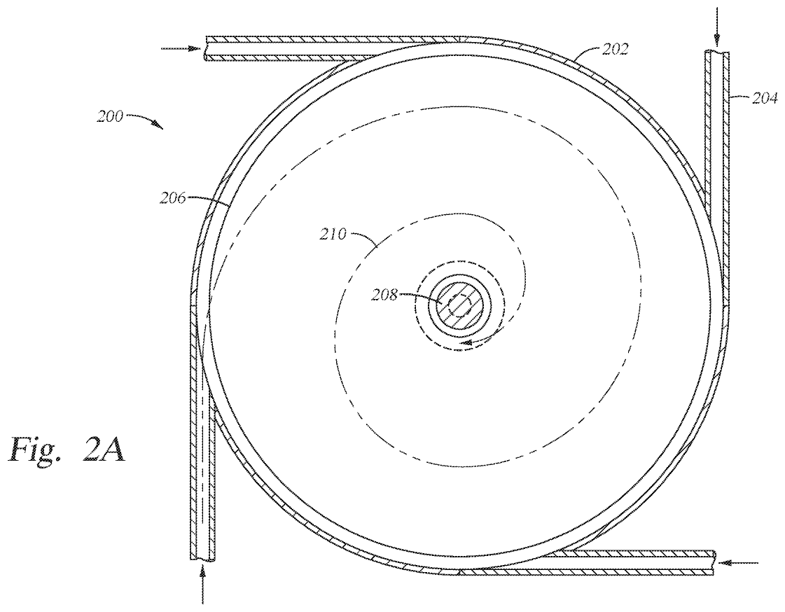

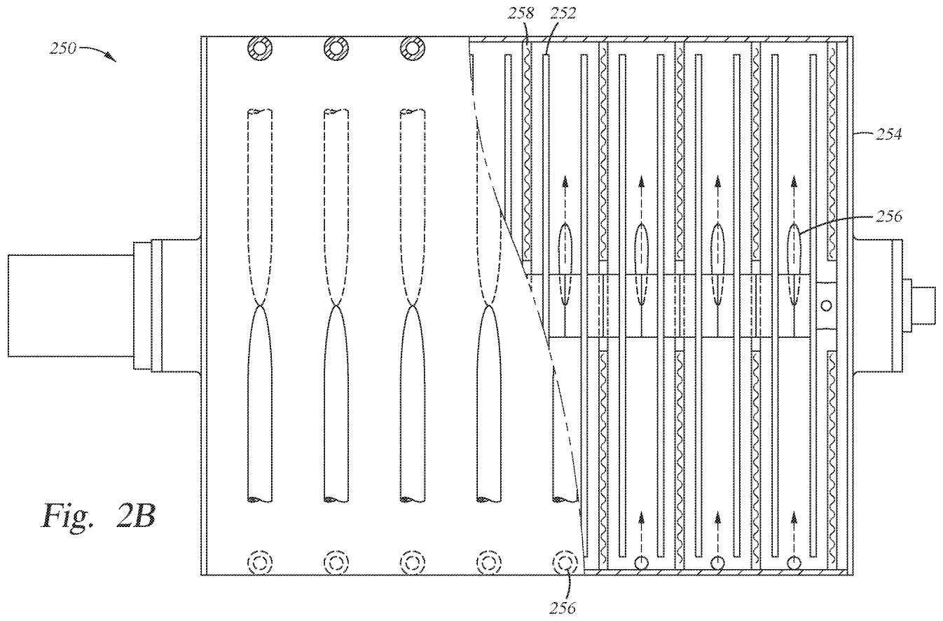

FIG. 2A is a cross-sectional view of a rotating disk reactor 200 according to another embodiment. In the version of FIG. 2A, the reactor 200 has a housing 202 with tangential inlets 204 at the periphery of the housing. The tangential inlets 204 are located to provide a flow of gas into the housing 202 along the periphery of a rotating disk 206 disposed within the housing 202. As in the reactor 100 of FIG. 1, the reactor 200 can have a plurality of the rotating disks 206 coupled to a rotor 208 within the housing 202. Here, the tangential inlets 204 are located at equal azimuthal spacing around the periphery of the housing 202, and while four such inlets 204 are shown here, any reasonable number of such inlets 204 can be used. The inlets 204 are located at the same axial location along the length of the housing 202, but tangential inlets 204 can be provided at different axial locations in some cases. For example, a first plurality of tangential inlets 204 can be located at a first axial location and a second plurality of tangential inlets 204 can be located at a second axial location different from the first axial location. The first and second pluralities of tangential inlets 204 can have the same number of inlets, the same azimuthal arrangement of inlets, different numbers of inlets, and/or different azimuthal arrangements of inlets.

Providing gas into the housing 202 in a tangential flow pattern at or near the periphery of the rotating disk 206 can maximize productive use of the disk surface by allowing a boundary layer flow to be established as near the edge of the disk 206 as possible. Where the gas flow from the tangential inlets 204 is substantially laminar, a boundary layer can form almost immediately when the gas reaches proximity to the rotating disk 206. As shown by arrow 210, rotation of the disk 206 influences flow of the gas along the surface of the disk 206 provides a path for interaction of the gas with the disk surface that is longer than a simple radial path from edge to center of the disk 206, thus providing longer residence time and reaction time as the gas interacts with the surface of the disk 206. It should be noted that in the case of FIG. 2A, the gas flow is provided in a direction that is the same as the direction of rotation of the disk 206 so that a boundary layer can be formed along the disk surface as soon as possible. In other cases, the gas flow could be provided in a direction that is opposite to the direction of disk rotation. In such cases, flow between two neighboring disks could be initially turbulent, so the gas would interact with the surfaces of two adjacent disks concurrently. Such methods could be used to create different effects using the two disk surfaces. In other cases, rather than tangential flow, as in FIG. 2A, gas flow could be introduced to the periphery of the housing 202 azimuthally, in a direction that forms an angle less than 90 degrees with a radius of the disk 206. The azimuthal angle could be nearly tangential, nearly radial, or any angle between tangential and radial.

FIG. 2B is a schematic partial cross-sectional view of a rotating disk reactor 250 according to another embodiment. The reactor 250 uses rotating disks 252 within a housing 254 that features tangential inlets 256 located at the periphery thereof. Like the reactor 200, the tangential inlets 256 are in groups, each group having four tangential inlets 256. The inlets 256 of each group are located at the same axial location of the housing 254 and have equal azimuthal spacing around the periphery of the housing 254. The variations in spacing, arrangement, and direction of the inlets can be varied as described above.

The reactor 250 has energy sources 258 that are like the inductive sources 122, disposed between the two disks of each neighboring pair of disks so that every other space between two neighboring disks has an energy source 258 extending radially inward from the wall 108. As in the reactor 100, every other space between neighboring disks has an energy source 258. In the reactor 250, the tangential inlets 256 are positioned to provide gas flow between two neighboring disks 252 where no energy source 258 is located to allow development of boundary layer flow along the surfaces of the rotating disks 252. In this case, inlets 256 are located substantially along the entire length of the housing 254, but in other cases inlets 256 can be located along part of the length of the housing 254, for example along about half the length of the housing 254. Any suitable length of the housing 254 can have tangential inlets arranged as shown in FIG. 2B.

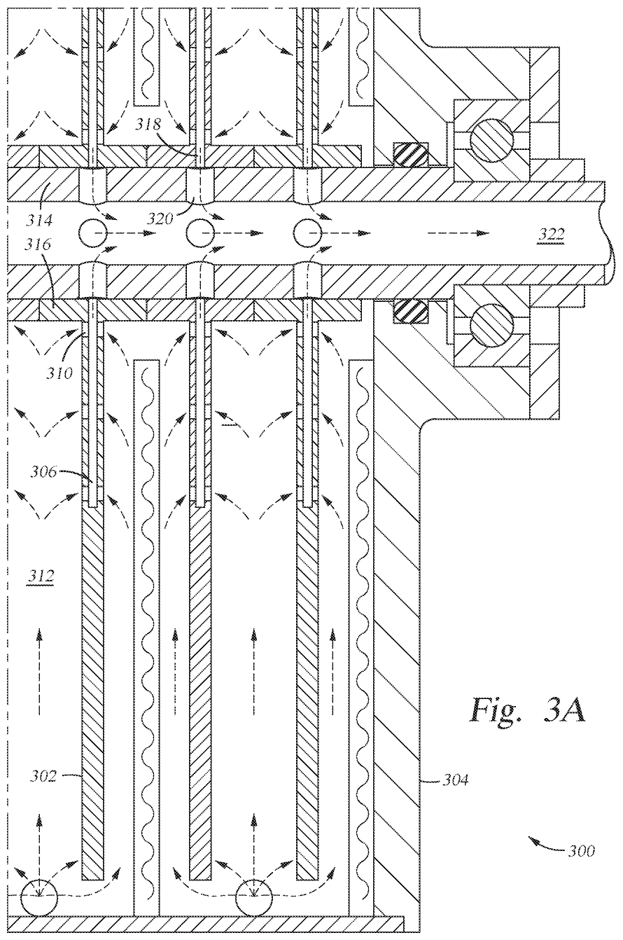

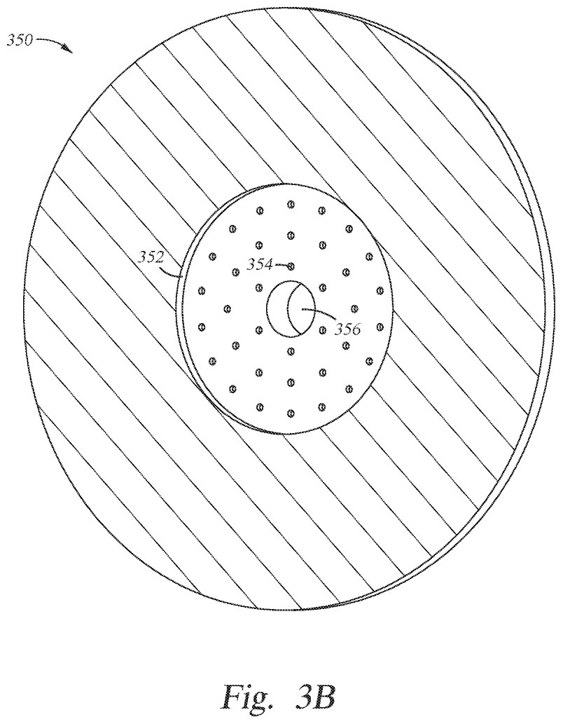

FIG. 3A is a detail view of a schematic cross-section of a reactor 300 according to another embodiment. The reactor 300 is similar in most respects to the reactors 100 and 200, using rotating disks to facilitate chemical reactions. The reactor 300 has a plurality of disks 302 that are rotated, as in other embodiments herein, within a housing 304. The disks 302 are partially hollow, having flow paths 306 within the disks 302 to facilitate gas flow within the housing 304. The flow paths 306 are one example of a flow guide that can be formed on or in the disks 302 (and any of the disks herein) to influence gas flow within the housing 304. Each of the disks 302 has at least one flow path 306 within a radially inward portion of the disk, Each disk 302 has a plurality of openings 310 that provide fluid communication between an interior 312 of the housing 304 and the flow path 306. The flow path 306 can be a conduit in some cases or a plenum in other cases. Thus, the flow path 306 could be a conduit that extends along a radius of the disk 302. Alternately, the flow path 306 could be a plenum that extends radially inward within the disk and in an azimuthal direction of the disk 302. The plenum can be continuous around the entire azimuthal extent of the disk 302, or multiple plenums might be provided within the disk 302, each having partial azimuthal extent.

In this cross-section, three openings 310 are visible formed through each major surface of the disk 302 to provide fluid communication between the interior 312 and the flow path 306. The three openings 310 shown in FIG. 3 are located along the same radius of the disk 302, thus arranged in a straight line toward the center of the disk 302. More of the openings 310 can be provided through one or both major surfaces of the disk 302 along multiple radii of the disk 302, if desired. Each disk 302 is attached to a rotor 314, which is also hollow, using a flange 316 as in the other embodiments above. Each disk 302 has one or more central openings 318, and the rotor 314 has a plurality of openings 320 in registration with the central openings 318 of the disks 302 to provide fluid communication from the flow paths 306 of the disks to an interior 322 of the rotor 314. Thus, gas is able to flow from the interior 312 of the housing through the openings 310 of the surface of a disk 302 into the corresponding flow path 306, along the flow path 306 through a central opening 318 and rotor opening 320 to the rotor interior 322. The rotor 314 is disposed through a seal coupling 324 to provide a path to exhaust gas from the reactor 300.

The disks 302 can be made by fusing together, using any suitable method such as welding, sintering, or adhering, two plates having features that combine to provide the features of the disks 302. FIG. 3B is a plan view of a plate 350 that can be used to make the disks 302. The plate 350 is a circular plate having a recess 352 in a central area thereof, with holes 354 located in the recess 352 and formed through the thickness of the plate 350. The holes 354 correspond to the openings 310, while the recess 352 corresponds to the flow path 306. As described above, the flow path 306 can be a plenum, which can be formed using plates like the plate 350. Two of the plates 350 can be adhered, with the recesses 352 facing, to form a disk 302. The recesses 352 of the two plates together define the plenum, which provides the flow path 306, and the holes 352 together form the openings 310. A rotor passage 356 formed at the center of the plate 350 and through the thickness of the plate 350 allows the plate 350 to be engaged with a rotor (not shown) that is disposed through the rotor passage 356 to rotate a disk made using the plate 350.

Here, the recess 352 forms a plenum when two identical plates 350 are fused. In other cases, plates having different designs can be fused to form disks with different characteristics. For example, two plates having matching holes and grooves can be fused, with the holes and grooves of each plate in registration with those of the other plate, to form a disk having openings and internal flow passages. In such cases, plates with radial grooves, and holes formed in the grooves, can be fused to form disks having internal linear flow passages extending along radii of the disk, each flow passage having openings to flow gas into the flow passages. In other cases, a plate like the plate 350, having holes within a recess, can be fused to a plate having a different design to create a disk having openings and internal flow passages according to any suitable configuration. The plates can be fused together by applying an adhesive material to one or both plates. Alternately, the plates can be fused together by heating the plates to a fusing temperature and bringing the plates together in facing contact.

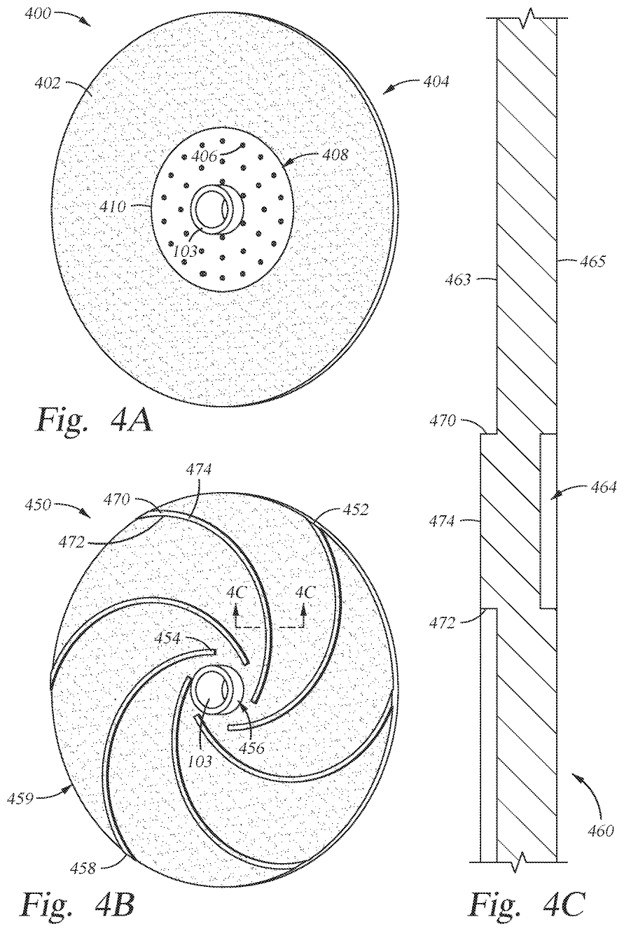

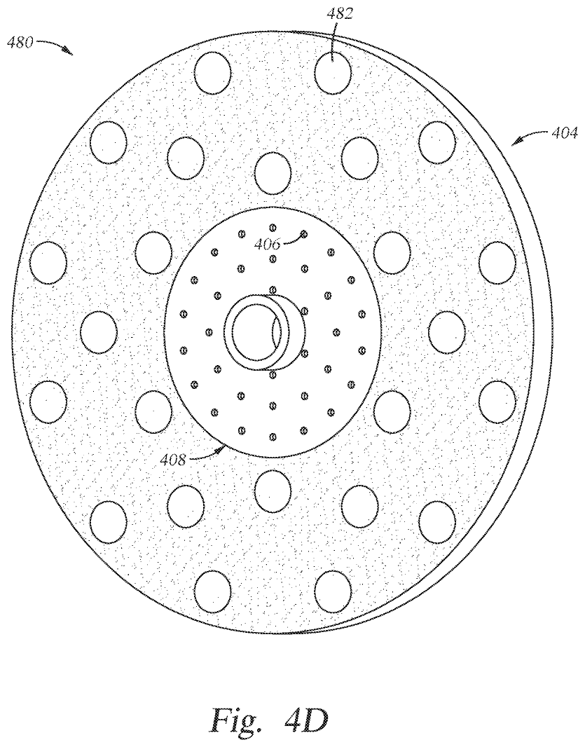

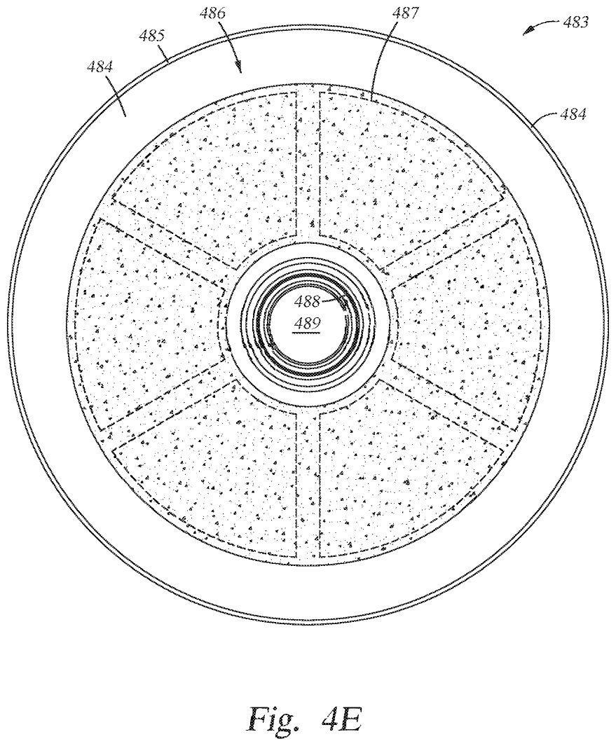

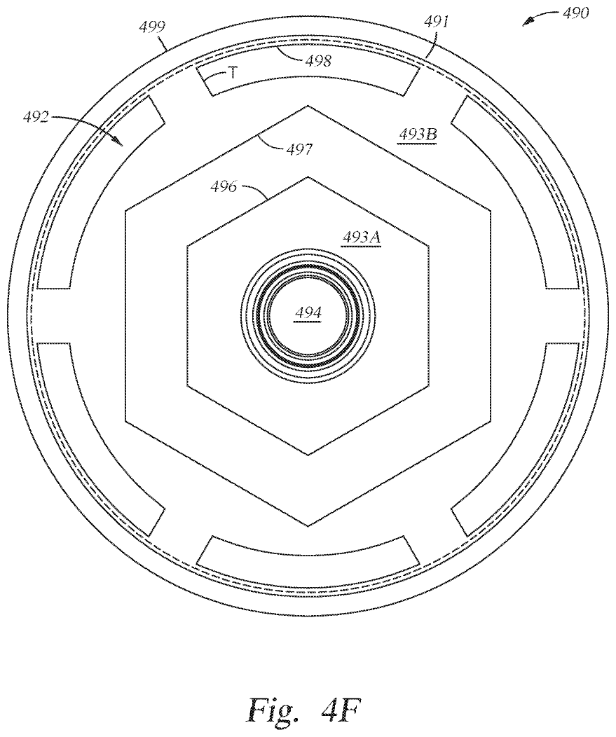

The disks can have many kinds of energy structures to encourage chemical reaction in gases that approach or contact the surface of the disks. Above, disks are described as being brought to a temperature that can cause chemical reactions and/or ionization of gases. FIG. 4A is an oblique view of a disk 400 that can be used in any of the rotating disk reactors described herein. The disk 400 has a catalytic surface 402 on an outer region 404 of the disk 400 and openings 406 at an inner region 408. The inner region 408 is located radially inward from the outer region The catalytic surface 402 may be a coating on the surface of the disk 400, or the portion of the disk 400 at the outer region 404 may be a homogeneous catalytic composition. The catalytic surface 402 may be, or may contain, a catalytic material such as a metal. Examples of such metals include platinum, palladium, rhenium, rhodium, copper, silver, vanadium, cobalt, nickel, zine, titanium, zirconium, ruthenium, indium, or any other catalytic metal. Combinations of such metals can also be used in the catalytic surface 402. The catalytic surface 402 may include a catalyst support material, such as a metal oxide, zeolite, or mixture thereof. The disk 400 can be coated with a catalyst support material, for example by plasma spraying, sputtering, or redox solution deposition. Materials such as silica, alumina, zirconia, titania, activated carbon, and other support materials can be coated onto the disk surface. Alternately, the disk 400 can be made of a catalyst support material, such as any of the aforementioned materials, and a catalytic material can be coated onto the disk surface.

The inner region 408 is hollow, as shown and described above, so the openings 406 provide fluid communication between the interior of the reactor housing that surrounds the disk 400 and the interior of the disk 400. As also noted above, the hollow interior of the disk 400 can be fluidly coupled to a hollow rotor (FIG. 3A) to provide an evacuation pathway for gases in the rotating disk reactor. A suction source or vacuum source can be coupled to the hollow rotor to provide pressure gradient for encouraging gas flow across the outer region 404 to the inner region 408, through the openings 406, and into a hollow rotor such that the inner region 408 is an evacuation zone of the disk 400. Such gas flow encourages gas to interact with the catalytic surface 402 for a residence time determined by the pressure drop established from the interior of the reactor to the outlet of the hollow rotor. The radial extent of the inner region 408 and the outer region 404, the radial location of a boundary 410 between the inner region 408 and the outer region 404, is selected to balance residence time for a gas in contact with, or proximity with, the catalytic surface 402 with suitable flow through the openings 406 at the inner region 408.

It should be noted that, in the embodiment of FIG. 4A, the inner region 408 is circular in shape and the openings 406 are distributed uniformly across the areal extent of the inner region 408. In other embodiments, the openings 406 could be arranged in one or more circles within the inner region 408. There could be one circle of openings 406 near the center of the disk 400 with an inner region 408 having radial extent no more than necessary to accommodate the one circle of openings 406. Thus, for a disk having a diameter of 12 inches or 200 mm, the inner region 408 could have radial dimension of 1 cm or less with one circular row of openings 406 therein to evacuate gas into the disk 400. In other embodiments, there could be multiple non-concentric rings of openings 406 in the inner region 408, where the rings of openings 406 are distributed uniformly within the inner region 408. In yet other embodiments, the openings 406 can be arranged along radii of the disk 400. Each radial row of openings 406, in such cases, can have the same number of openings 406, or different radial rows can have different numbers of openings 406.

FIG. 4B is an oblique view of a disk 450 for use in a rotating disk reactor according to another embodiment. The disk 450 has flow guides 452 for influencing flow of gas along the surface of the disk 450. The flow guides 452 of the disk 450 can be ridges, bumps, grooves, or any surface feature formed on the surface of the disk 450 to divert flow of a gas boundary layer. In this case, the flow guides 452 are ridges formed in a spiral pattern from a central area of the disk 450 to a peripheral area of the disk 450. Six flow guides are shown on the disk 450, shown on one side of the disk 450, but any number of flow guides can be used and can be provided in any pattern suited to influencing a desired gas flow along the surface of the disk. For example, ridges or grooves can be provided extending along radii of the disk from the central area to the peripheral area of the disk, or partway from the central area to the peripheral area of the disk. The spiral pattern of flow guides shown in FIG. 4B can also be realized in flow guides extending partway from the central area to the peripheral area of the disk 450. In this case, each flow guide is continuous, extending from a starting point 454 in the central region 456 of the disk 450 to an ending point 458 in the peripheral region 459 of the disk 450, with no gaps or interruptions. In other cases, flow guides can be segmented, as raised segmented portions or recessed segmented portions according to any suitable pattern. For example, a segmented flow guide can use a plurality of bumps or depressions arranged in a pattern. Each of the disks 400 and 450 of FIGS. 4A and 4B has the coupling 103 that allows the disk to be coupled to a rotor as described above.

The disk 450 has flow guides 452 on both major surfaces, a first surface opposite from a second surface, of the disk 450. All the flow guides 452 can be ridges, bumps, or other raised features. Alternately, all the flow guides 452 can be grooves channels, or other recessed features. In other cases, the flow guides 452 can be a combination or mixture of raised features and recessed features. For example, flow guides 452 can be alternated ridges and grooves, which can be spiral features like the features shown in FIG. 4B. FIG. 4C is a schematic cross-section of a portion of a disk 460 according to one embodiment. This disk, 460, has flow guides that include raised features and recessed features. In this view, a raised feature 462 is located on a first side 463 of the disk 460 and a recessed feature 464 is located on a second side 465 of the disk 460, opposite from the first side 463. The raised feature 462 and the recessed feature 464 are located, in this case, at a same radial distance of the disk 460, but in other cases such features can be located at different radial distances.

The flow guides shown in FIGS. 4B and 4C are all uniform in width, but other cases can have flow guides with varying width. Each of the flow guides shown in FIG. 4B comprises a first vertical wall 470 (vertical in the neighborhood of the flow guide), a second vertical wall 472, and a horizontal portion 474 connecting the first and second vertical walls 470 and 472. For the flow guides of FIG. 4B, the first and second vertical walls 470 and 472 are parallel along the entire curve of the flow guide. In other cases, the first and second vertical walls 470 and 472 could be non-parallel. For example, in one case, the vertical walls of the flow guides could diverge or converge uniformly or non-uniformly with distance from the center of the disk 450. In other cases, the vertical walls might converge and/or diverge in any suitable pattern.

The disks for a rotating disk reactor can use other forms of electromagnetic energy. FIG. 4D is an oblique view of a disk 480 that can be used in a rotating disk reactor such as the reactors 100, 200, and 300. The disk 480 has a plurality of magnetic members 482 disposed in the structure of the disk 480. In this case, the magnetic members 482 are small disks that are embedded in the disk 480. The magnetic members 482, in this case, are exposed at both surfaces of the disk 480 (only one major surface of the disk 480 is visible in FIG. 4D), so each of the magnetic members 482 has a thickness that is equal to, or greater than, a thickness of the area of the disk 480 not having a magnetic member. The magnetic members 482 are generally distributed uniformly across the disk 480 with spacing that can be selected to provide desired electromagnetic effects. In this case, the magnetic members 482 are disposed in the outer region 404 of the disk 480. Also in this case, the inner region 408 of the disk 480 has the openings 406 that provide fluid communication into a plenum within the disk 480, as in other embodiments herein. The plenum and openings are optional, so in some cases, substantially the entire disk, from edge to center, can have magnetic members 482.

The magnetic members 482 can be disks having thickness less than the thickness of the disk 480. The magnetic members 482 can also be coatings of magnetic material on the surface of the disk 480. The material of the magnetic members 482 has a permanent magnetization and permanent magnetic field. Materials such as europium, neodymium, samarium, and combinations with cobalt, iron, and boron can be used as permanent magnetic materials for disks such as the disk 480.

FIG. 4E is a plan view of a disk 483 that can be used in a rotating disk reactor like those described herein. The disk 483 has a hollow outer body 484 defined by an outer wall 485 that is disk shaped and encloses a disk shaped interior The disk 483 also has an inner body 487 disposed within the outer body 484. The inner body 487 is shown in phantom here. The inner body 487 is a solid body that is made of a magnetic material that creates a persistent magnetic field of its own, sometimes referred to as a “permanent” magnet. The outer body 484 can be made of any suitable material, such as a metal, that can be attached to the inner body 487 such that the two bodies will move as a unit. The outer body 484 can be made of the same magnetic material as the inner body 487 in some cases to avoid detachment where thermal cycling can cause undesirable dimensional changes in materials. The disk 483 has a rotational bearing 488 disposed around a central opening 489 of the disk 483. The central opening 489 can be used to accommodate a rotor as shown in the reactors described herein. The rotational bearing 488 can be used to contact an outer surface of a rotor to provide free rotation of the disk 483 about the rotor so that rotational motion of the disk 483 is substantially decoupled from the rotor. The interior 486 of the disk 483 can also be used to provide an interior flow path like the flow path 306 described in connection with FIG. 3A. In such cases, the outer body 484 can be porous or can have holes or openings to admit gas flow to the interior of the disk 483 over the entire area of one or both of the two major surfaces of the outer body 484, or over only part of the area. Additionally, or instead, the outer body 484 can have a catalyst material coating the exterior of one or both of the two major surfaces of the outer body 484, or over only part of the area.

FIG. 4F is a plan view of a portion of a disk 490 that can be used in a rotating disk reactor like those described herein. The disk 490 is sectioned along the plane of the disk so interior structures of the disk 490 can be seen. The disk 490 has an outer body 491 similar to the outer body 484 of the disk 483, forming a hollow interior 492 that is disk shaped. The disk 490 has two inner bodies, a first inner body 493A and a second inner body 493B. The first inner body 493A is disposed around a central opening 494 of the disk 490 in contact with an inner radial wall 495 of the disk The rotational bearing 488 is disposed within the central opening 494, as in the disk 483 of FIG. 4E. The second inner body 493B is disposed around the first inner body 493A, and spaced radially outward from the first inner body 493A forming a gap between the first and second inner bodies 493A and 493B around the entire circumference of the first inner body 493A. Here, the first inner body 493A has an outer edge 496 with the shape of a regular hexagon. The second inner body 493B has a matching inner edge 497 with the shape of a regular hexagon so that the gap between the outer edge 496 and the inner edge 497 has the shape of a regular hexagonal channel of uniform width.

The second inner body 493B is attached to an inner surface 498 of an outer wall 499 of the outer body 491 by a plurality of tabs T. As in the disk 483, both inner bodies 493A and 493B are made of persistently magnetized metal. The outer body 491 can also be metal, and can be made of the same material as the inner bodies 493A and 493B, or a different metal. Alternately, the outer body can have a metal inner surface with a non-metallic outer surface. The tabs of the second inner body 493B can be attached to the metal inner surface 498 of the outer wall 499 by low intensity metal joining, such as brazing, to avoid generally disrupting the magnetic properties of the second inner body 493B. The first inner body 493A can be likewise attached to the inner radial wall 495 by low intensity metal joining. Joined this way to the outer body 491, the two inner bodies 493A and 493B move with the outer body 491 so the disk 490 behaves as a single unit. As with the disk 483 of FIG. 4E, the rotational bearing of the disk 490 enables the disk 490 be rotationally decoupled from a rotor disposed through the central opening 494.

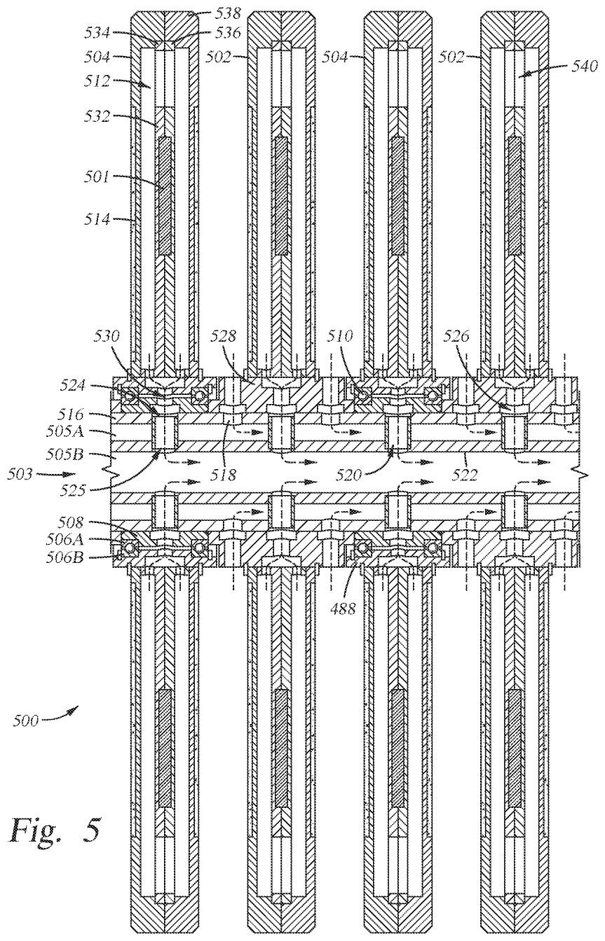

A disk like the disk 483 of FIG. 4E or 490 of FIG. 4F can be used in a rotating disk reactor to create electromagnetic effects that can enhance chemical reactions. FIG. 5 is a cross-sectional view of a rotating disk reactor 500 according to another embodiment. The reactor 500 is similar to the reactors 100, 200, and 300 in many ways. The reactor 500 is different in that it uses disks like the disk 483 of FIG. 4E or 490 of FIG. 4F to create dynamic magnetic fields within the interior of the reactor to enhance chemical reactions. In the reactor 500, every disk has a magnetic member 501 within the interior of the disk. A plurality of first disks 502 in the reactor 500, each of which has an interior magnetic member 501, is rotationally coupled to a rotor 503. The rotor 503 is hollow and has two concentric axial flow paths, an outer flow path 505A and an inner flow path 505B. As the rotor 503 rotates, the first disks 502 rotate with the rotor 503.

A plurality of second disks 504 in the reactor 500 are like the disk 490, coupled to the rotor 503 by the rotational bearing 488. In this case, each rotational bearing 488 has an inner ring 506A that is rotationally coupled to the rotor 503. A hub 508 is disposed around the outer surface of the rotor 503, and in contact therewith, and the inner ring 506A is coupled to the hub. The inner ring 506A may be permanently attached to the hub 508, while the hub 508 is removably attached to the rotor 503. The rotational bearing 488 also has an outer ring 506B disposed around the inner ring 506A and concentric therewith. The outer ring 506B and the inner ring 506A are coupled by roller bearings 510 that contact both the inner and outer rings 506A and 506B, for example in a groove formed in the facing surfaces of the inner and outer rings 506A and 506B and shaped to receive the roller bearings 510, to provide rotational coupling between the inner and outer rings 506A and 506B. The outer ring 506B is coupled to the disk 504. In this way, the disk 504 is rotationally decoupled from the rotor 503 by co-operation of the inner and outer rings 506A and 506B and the roller bearings 510.

The first and second plurality of disks 502 and 504 are interleaved along the axial length of the rotor 503, so the disks of the reactor 500 alternate between the disks 502 that are rotationally coupled to the rotor 503 and the disks 504 that are rotationally decoupled from the rotor 503. In this way, as the rotor 503 rotates, the first disks 502 attached to the rotor 503 rotate to create a rotating magnetic field emanating from the magnetic members 501 of the first disks 502. The rotating magnetic field interacts with the rotationally decoupled second disks 504 to cause rotational motion of the second disks 504 that is driven by the dynamic interaction of the magnetic fields of the magnetic members 501 of the first disks 502 and the second disks 504. It is believed that interaction of the magnetic fields of the two sets of disks, while the first disks 502 rotate at a high rate, for example more than 1,000 rpm, such as 10,000 rpm, can create an RF field within the interior of the reactor 500.

The magnetic member 501 of each disk 502 and 504 is an inner body of the disk, as described above in connection with FIGS. 4E and 4F. Each magnetic member 501 is disposed within a hollow interior 512 of the respective disk. Each disk 502 and 504 has an outer surface 514 that provides fluid communication between the interior 512 of each disk and the interior of the reactor 500 external to each disk. Gas can thus flow through a surface of each disk into the interior 512 of the disk. In this case, the interior 512 of each of the disks is in fluid communication with the inner flow path 505B of the rotor 503 while the interior of the reactor 500 external to the disks is in fluid communication with the outer flow path 505A of the rotor 503. In this way, gases that flow through the surfaces of the disks can be separated from gases that do not flow through the surfaces of the disks. An outer wall 516 of the rotor 503 has a plurality of openings 518 that provide fluid communication with the outer flow path 505A. A plurality of conduits 520 extend from the outer wall 516 of the rotor 503 to an inner wall 522 of the rotor 503, where the outer wall 516 and the inner wall 522 defined the outer flow path 505A between them and the interior of the rotor 503 enclosed by the inner wall 522 defines the inner flow path 505B. Each conduit 520 has an opening 524 at the outer wall 516 and an opening 525 at the inner wall 522. Each conduit 520 is also fluidly coupled with disk openings 526 at an inner radial wall 528 of each disk. The disk openings 526 provide fluid communication with a conduit 530 through the inner radial wall 528 of each disk to the disk interior 512. In this way, gases that flow through a gas permeable surface of each disk into the hollow interior 512 thereof can flow toward the rotor 503, into the conduit 530 and through the disk opening 526 into the rotor conduit 520 to the inner flow path 505B.

Process gases thus flow around the magnetic members 501 in the interior 512 of each disk 502 or 504. To protect the metallic magnetic members 501 from chemical attack by reactive process gases, each magnetic member 501 can be encapsulated in a resistant member 532. The resistant member 532 can be a flat inner body, like the inner bodies of the disks 483 and 490 of FIGS. 4E and 4F, with a hollow inner space to receive the magnetic member 501. Alternately, the resistant member 532 can be a resistant coating formed over the magnetic member 501. The resistant member 532 may be a material that is thermally compatible with the material of the magnetic member, such that thermal cycling causes minimal dimensional disruption. The resistant member 532 is made of a material that is resistant to chemical attack by process gases. The resistant member 532 may be made of metals such as titanium, tantalum, zirconium, gold, and the like, and combinations thereof. Alloys of such metals can be used to target thermal expansion characteristics that match thermal expansion characteristics of the magnetic member 501 so there is no differential expansion or contraction of the resistant member 532 and the magnetic member 501 with temperature changes. The resistant member 532 can be coated onto the magnetic member to a thickness of, for example 10-50 μm using conventional vapor deposition techniques.

In this case, the resistant member 532 is a plate-like structure that enclosesthe magnetic member 501. The resistant member 532 has an outer rim 534 that contacts an inner surface 536 of the outer body 538 of the disk. Here, the outer body 538 is two pieces that can be joined to simplify construction of the disk. The resistant member 532, enclosing the magnetic member 501, is placed into a first piece of the outer body 538 such that the outer rim 534 of the resistant member 532 rests within a rim of the first piece. At that stage, the resistant member 532 can be attached to the first piece of the outer body 538 by low intensity metal joining, such as brazing, to avoid adverse heating of the magnetic member 501. A second piece of the outer body 538 is then placed over the resistant member 532 and in contact with the first piece of the outer body 538 at the outer rim 534 of the resistant member 532. The pieces of the outer body 538 can then be joined by low intensity metal joining to form the disk. Each resistant member 532 has at least one opening 540 that provides fluid communication within the interior 512 of the disk from one side of the resistant member 532 to the opposite side to facilitate gas flow within the disk.

In operation, the rotor 503 of the reactor 500 is rotated at a high rate while a gas to be processed is introduced to the interior of the reactor 500. Rotation of the rotor 503 rotates the first disks 502. The rotating magnetic field produced by rotation of the first disks 502 interacts with the magnetic field of the second disks 504 to produce a potentially chaotic motion of the second disks 504. Interaction of the magnetic fields of the two sets of disks 502 and 504 creates a potentially chaotic magnetic field within the reactor interior. Rotation rate of the first disks 502 can be adjusted to give rise to a magnetic oscillation within the reactor 500 interior that approximates a radio frequency oscillation, or other desired frequency, to encourage activation of molecules in the gas phase of the reactor 500 interior. This activation can be ionization in some cases, or merely expansion of electron clouds around the molecules to higher energy states by absorbing energy from the oscillating magnetic field.

The disks 502 and 504 can be configured to separate species in the gas phase of the reactor 500 interior. A catalytic coating can be disposed on the gas permeable outer surface of any of the disks 502 and 504 to encourage compatible species to flow through the outer surface of the disk into the disk interior 512 and to discourage incompatible species from flowing into the disk. Metal catalysts such as nickel and platinum can be deposited on the gas permeable outer surface of such a disk to perform such function. Where the disk has a porous outer surface, deposition of the metal catalyst may be limited to avoid reducing flow through the porous material.

As noted above, the rotating disks having permanent magnetic components can be used to generate reactive electromagnetic fields such as RF fields to facilitate chemical reactions. Rapidly rotating the disks having the magnetic components can generate a field that induces electron motion in a gas. With enough applied energy, the electromagnetic field generated by the rotating disks (and optionally by rotationally uncoupled disks having permanent magnetic components) can ionize, or otherwise activate, gases to bring the gases to a reactive state. In such state, any desired reaction can be performed subject to the properties of the ions and molecules in the gas. In some cases, such methods can be used to generate a plasma by applying an RF field to a gas. Use of such methods can reduce the temperatures needed to perform a chemical reaction by providing electromagnetic energy to replace a certain amount of thermal energy. In such cases, the magnetic components of the various disks will usually be made of high temperature magnetically persistent materials, such as aluminum-nickel-cobalt alloy (525 cc) or samarium-cobalt alloy (400 cc).

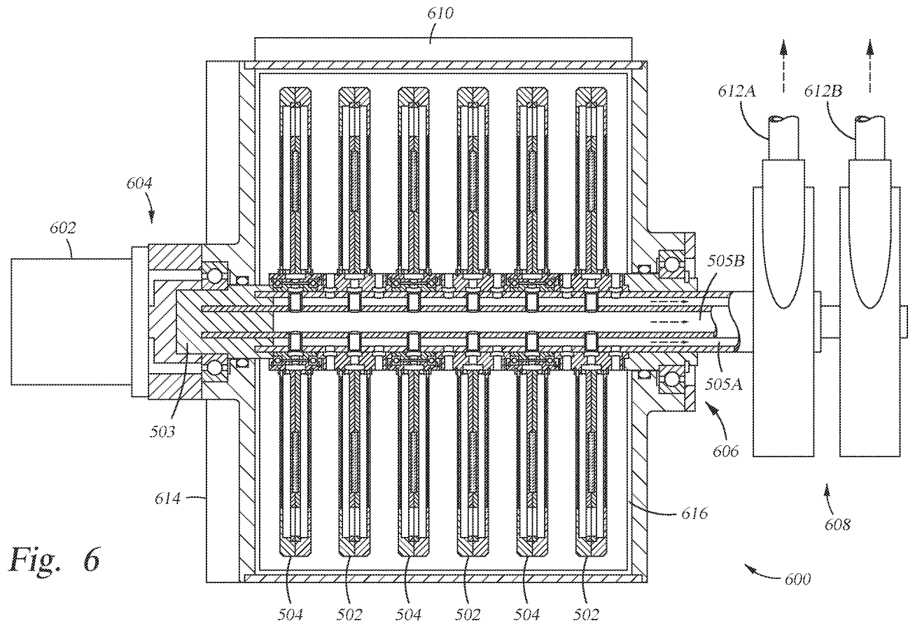

FIG. 6 is a schematic cross-sectional view of a rotating disk reactor 600 according to another embodiment. The reactor 600 uses the disks of the reactor 500 of FIG. 5, in the same configuration, along with the same double-hollow rotor 503, to perform chemical transformations of gases and to separate the products. A motor 602, located at a first end 604 of the reactor 600, drives rotational motion of the rotor The rotor 503 extends through the reactor 600 from the first end 604 through a second end 606 of the reactor 600, opposite from the first end 604, to the exterior of the reactor 600. A two-stage pump 608 is coupled to the rotor 603 at the second end 606 of the reactor 600 to provide pumping energy to the interior of the reactor 600. Rotation of the rotor 603 thus also drives the two-stage pump 608. The two-stage pump 608 reduces pressure in the flow paths of the rotor 503 to encourage gases to flow into the disks of the reactor 600, into the rotor 503, and out through the pump 608. The two-stage pump 608 is configured to apply pumping to each flow path ofthe rotor 503 independently.

Thus, the first stage of the two-stage pump 608 may be fluidly coupled to the outer flow path 505A while the second stage of the two-stage pump 608 is fluid coupled to the inner flow path 505B.

The reactor 600 can be used, for example, to perform a water-splitting reaction, which can be a urea-assisted water-splitting reaction. The reactor 600 has a feed manifold 610 at a side of the reactor 600 to transfer feed gases into the reactor 600. The manifold 610 can include a plurality of ports that provide fluid communication into the interior of the reactor 600 where the rotating disks engage with the feed gases and distribute the feed gases within the reactor 600 interior. The disks can be coated with catalyst materials such as metals, for example noble metals, that can catalyze the water-splitting reaction and can selectively permit hydrogen, as ions or molecules, to pass into the disks. For example, cobalt phosphide and nickel phosphide, alone or combined, can be used to catalyst a water-splitting reaction that uses urea as accelerant. Hydroxyl ions, and other ions, continue to react in the interior of the reactor 600 forming molecular hydrogen, oxygen, and nitrogen. The selectively permeable disks allow hydrogen to enter but selectively prevent other species from entering, thus achieving a separation of hydrogen from other species. As noted above in the description of the disks in FIG. 5, gases in the interior of the disks pass into the rotor inner flow path 505B while other gases evacuate through the outer flow path 505A by operation of the two-stage pump 608. The two-stage pump 608 has a first effluent 612A that can evacuate the outer flow path 505A and a second effluent 612B that can evacuate the inner flow path 505B. The two effluents 612A and 612B can provide substantially separated molecular hydrogen at the second effluent 612B and a mixture of oxygen and other gases at the first effluent 612A.

As noted above, rotation of the rotor 503 forces rotation of the first disks 502 that are rotationally coupled to the rotor 503. Interaction of the magnetic fields of the magnetic members 501 of the first and second disks 502 and 504 forces movement of the second disks 504 and creates an electromagnetic field within the interior of the reactor 600 that can energize, and potentially ionize, gases to perform the reactions within the reactor 600. An inductive heater 614 can also be provided to assist with energizing gases to react within the reactor 600. Here, the inductive heater 614 is located adjacent to the first end 604 of the reactor 600, but such elements can be arranged in any convenient manner. As noted above, the reactor 600 can include a field enhancing liner 616 to enhance electromagnetic fields within the reactor 600, for example by reflecting RF radiation.

In all cases herein, where a plasma is formed, a plasma forming gas can be provided along with reactant gases to help support an ionized state. For example, in an industrial stream to be treated to remove active species before release to the environment, a plasma forming gas such as argon or helium can be added to the industrial stream to form a mixture, and the mixture can be provided to a rotating disk reactor that will heat the gas, or create an ionizing electromagnetic field. The plasma forming gas in the mixture can facilitate formation of a plasma by ionizing at lower energies than other species in the mixture to form ions and electrons that can better accomplish ionization of other species in the mixture.

In cases where plasma formation is utilized to enhance chemical reactions, a reactor like the reactor 500 that can generate plasma may include components that enhance and/or focus an activating electromagnetic field. For example, in the reactor 500, the housing 104 may be lined, along the interior surface 119, with a field-enhancing material. The field-enhancing material may be configured to reflect RF electromagnetic energy. Examples of such materials include any variety of mu-metal or any of the Fluxtrol materials available from Fluxtrol, Inc., of Auburn Hills, Michigan. These materials can reduce leakage of the activating electromagnetic field outside the housing 104 of the reactor 500 to increase activation of process gases.

In some cases, a rotating disk reactor such as the reactors 100, 200, and 300, can have some disks that do not rotate. Such disks can be provided to achieve certain desired gas flow patterns within the reactors. For example, in the reactor 100 all the disks 102 are attached to the rotor 106, which rotates. In other cases, one or more of the disks 102 could be attached to the wall 108 at the inner surface thereof, and not attached to the rotor 106. Such disks would not rotate with the rotor 106, but would remain stationary within the housing 104. Such stationary disks, within a rotating disk reactor, can direct gas flow toward the rotor 106 of the reactor to increase residence time and contact with disks to facilitate reactions. Thus, for example, a rotating disk reactor can have one or more stationary disks within the housing thereof. Such reactors might have a stationary disk between two rotating disks. For example, every other disk could be a stationary disk, and each stationary disk could be located between two rotating disks. The stationary disks can be attached to the reactor wall discontinuously, using tabs for example, such that gas can still flow around the edges of the disk along the interior of the reactor.

In one example of a rotating disk reactor that has a plurality of rotatable disks and a plurality of non-rotatable disks, the rotatable disks can have magnetic components to project a magnetic field surrounding each rotatable disk, and the non-rotatable disks can have magnetic susceptibility of any suitable form. For example, where rotatable disks are alternated with non-rotatable disks, the rotatable disks can have magnetic components and the non-rotatable disks can include electrically conductive materials or components to react to the magnetic field created by the rotatable disks. The non-rotatable disks can be made of, or can include, for example, components of gold, silver, copper, aluminum, and other electrically conductive materials. Where the electrically conductive material may be reactive to one or more species to be encountered within the interior of the rotating disk reactor, at least the electrically conductive portions of the non-rotatable disks, potentially including the entirety of each disk, can be coated with a chemically resistant material such as ceramic or glass. The electrically conductive components can react to the rotating magnetic field produced by rotation of the rotatable disks having magnetic components by producing electrical currents which can raise a temperature of the non-rotatable disks. In a type of inductive heating, the non-rotatable disks can be warmed, by rotation of the rotatable disks having magnetic components, to a temperature that facilitates a chemical reaction in molecules that approach the non-rotatable disks. Where the non-rotatable disks include electrically conductive and electrically non-conductive components, such components can be formed in patterns within, or on a surface of, the non-rotatable disk to provide desired current flow patterns and/or heating patterns.

The rotating disk reactors described herein can be used to perform a number of chemical reactions. In one method, a gas stream having one or more chemicals to be removed can be provided to a rotating disk reactor, as described herein, to transform the one or more chemicals into another substance. For example, where a stream contains a species that cannot be released to the environment, a rotating disk reactor, as described herein, can be used to transform the species into an environmentally benign material.

Many different reactions can be performed using rotating disk reactors. Polymerization reactions can be performed using rotating disk reactors by coating the disks with a polymerization catalyst, such as a Zeigler-Natta catalyst, and providing olefin reactants to interact with the disk surfaces. Hydrogenation reactions can be performed using a rotating disk reactor by coating the disks with a hydrogenation catalyst and providing the chemical to be hydrogenated, along with hydrogen gas, to the reactor. Pyrolysis and catalysis reactions can be performed using rotating disk reactors by providing molecules to be divided in a lysis reaction to a rotating disk reactor having disks configured to split the molecules. For example, a rotating disk reactor can be used to split water molecules into hydrogen gas and oxygen gas using disks that can be used to heat gas molecules to a decomposition or ionization temperature. Redox reactions can also be performed using rotating disk reactors by using disks made of, or coated with, proper activating chemicals, which may be catalysts for redox reactions, or using disks that can absorb and emit thermal energy to heat reactants.

The reactants in all these cases can be introduced to the interior of the rotating disk reactor through any combination of axial and peripheral feed patterns, which may include tangential, radial, and/or azimuthal feed directions in any suitable form or combination. One or more gases can be introduced at an axial location (a location at or near an axis of the rotating disk reactor) at an end (i.e. the first end 118 or the second end 120 described above) of the housing. Alternately, one or more gases can be introduced to the reactor at an axial location that is not at an end of the reactor, for example by extending a flow conduit through the wall of the housing in a radial direction of the reactor from the periphery of the housing to the axial location where the one or more gases are to be introduced. Such a flow conduit can extend between two neighboring disks in a space where no other structures (such as thermal elements) are interrupted by the flow conduit. Gases can be introduced at multiple points of a rotating disk reactor, any of which may be at axial locations, peripheral locations, or locations intermediate between axial and peripheral locations, and which may be at end locations (i.e. at the first or second end) or at locations intermediate between the two ends of the reactor. Any of the points at which gases are introduced can flow gas into the reactor in a direction perpendicular to the reactor wall at the location the gas flow enters the reactor, tangent to the reactor wall at the location the gas flow enters the reactor, or in a direction intermediate between perpendicular and tangential.

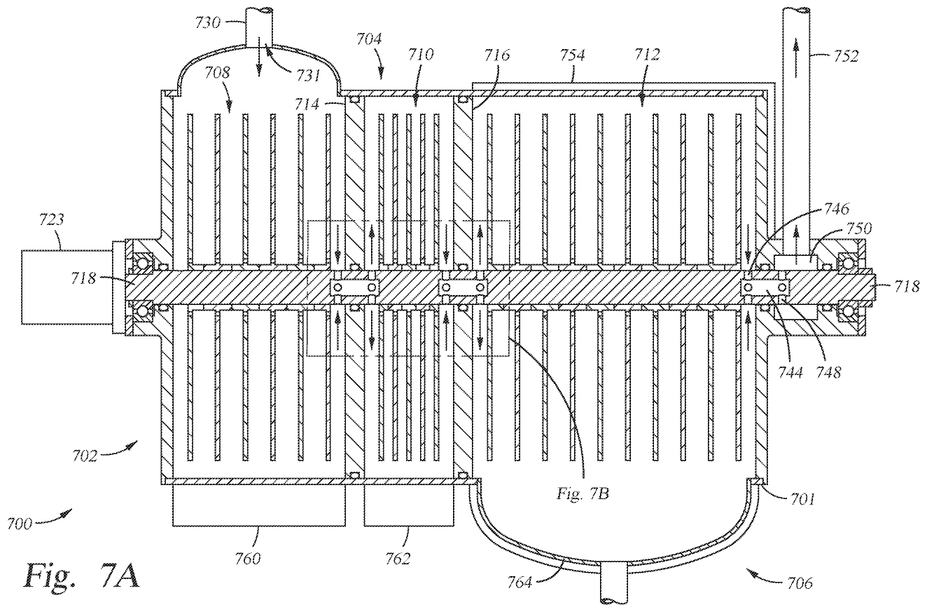

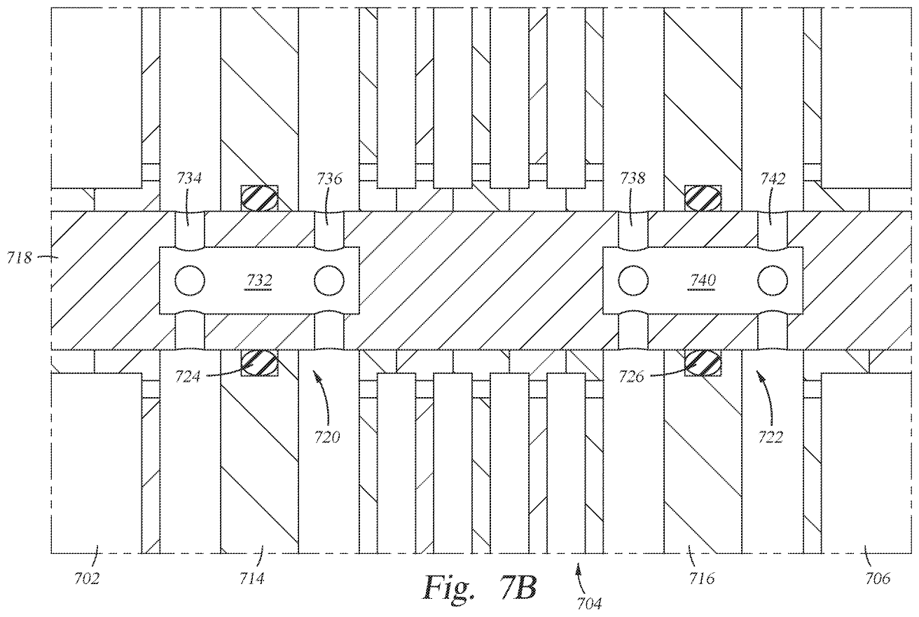

Rotating disk reactors can be configured for staged processing. FIG. 7A is a schematic cross-sectional view of a rotating disk reactor 700 according to one embodiment. FIG. 7B is a detail view of a portion of the reactor cross-section of FIG. 7A. The reactor 700 has three stages, a first stage 702, a second stage 704, and a third stage 706 all in a single housing 701 of the reactor. Each of the first, second, and third stages 702, 704, 706 uses rotating disks to facilitate chemical reactions. The first stage 702 uses a first plurality 708 of rotating disks to facilitate a first reaction within the first stage 702, a second plurality 710 of rotating disks to facilitate a second reaction within the second stage 704, and a third plurality 712 of rotating disks to facilitate a third reaction within the third stage 706.

A first wall 714 separates the first stage 702 from the second stage 704 within the housing 701 and a second wall 716 separates the second stage 704 from the third stage 706 within the housing. The disks of the three stages are all coupled to a single common rotor 718 that extends along a central axis of the housing 701, which has a generally cylindrical overall form. Referring to FIG. 7B, the first wall 714 has a first opening 720 that accommodates the rotor 718 to extend through the first wall 714 from the first stage 702 to the second stage 704, and the second wall 716 has a second opening 722 for a similar purpose. The first and second walls 714 and 716 having generally circular shapes to match the generally cylindrical profile of the reactor 700, the openings 720 and 722 are located at the center of the first wall 714 and the second wall 716, respectively. The rotor 718 extends through the wall of the housing 701 to couple with a motor 723 external to the housing 701. In this case, the motor 723 is on-axis with the reactor housing 701.

The first and second walls 714 and 716 can be formed integrally with the rest of the housing, or as shown here in FIG. 7A the walls can be separate members attached to the housing 701 in a suitable way. Seals can be used at the first and second walls 714 and 716, at the interface of the walls 714 and 716 with the rotor Seals can also be used where the walls 714 and 716 may, in some cases, be attached to the housing 701. Referring again to FIG. 7B, in this case, the openings 720 and 722 are sealed against the rotor 718 using respective seals 724 and 726, which can be rotational seals of any suitable variety.

The reactor 700 is configured such that gases can flow from the first stage 702 to the second stage 704 to the third stage 706. As shown in FIG. 7A, reactant gas is provided to the first stage 702 through an inlet 730, which in this case is a side inlet located at one side of the first stage 702. Any suitable configuration of inlet can be used here, including any of the configurations described earlier. Here, the inlet 730 is configured as a plenum into which gas is provided through a port 731 and allowed to fill the plenum and flow into interaction with the rotating disks of the first stage 702. Referring again to FIG. 7B, near the first wall 714, on a side of the first wall 714 exposed to the first stage 702, the rotor 718 has a first internal passage 732 to provide fluid communication between the first stage 702 and the second stage 704. A plurality of first openings 734 is formed in the exterior surface of the rotor 718, each first opening 734 in fluid communication with the first internal passage 732, adjacent to the first wall 714 on the first stage 702 side of the first wall 714 to provide a gas outlet for the first stage 702. A plurality of second openings 736 is formed in the exterior surface of the rotor 718, each second opening 736 also in fluid communication with the first internal passage 732, adjacent to the first wall 714 of the second stage 704 side of the first wall 714 to provide gas inlet to the second stage 704. Gas in the first stage 702, after interacting with the disks of the first plurality 708 for a first residence time, flows into the first openings 734, through the first passage 732, and out of the second openings 736 into the second stage 704.

Similar to the first wall 714, near the second wall 716, the rotor has a third plurality of openings 738 fluidly connected with a second internal passage 740 to a fourth plurality of openings 742. The third openings 738 are located adjacent to the second wall 716 on the second stage side of the second wall 716 and the fourth openings 742 are located adjacent to the second wall 716 on the third stage side of the second wall 716. The third openings 738, second internal passage 740, and fourth openings 742 provide a gas flow path from the second stage 704 to the third stage 706. Gas in the second stage 704, after interacting with the disks of the second plurality 710 for a second residence time, flows into the third openings 738, through the second internal passage 740, and out of the fourth openings 742 into the third stage 706.

Referring again to FIG. 7A, in this case, the rotor 718 has a third internal passage 744, a fifth plurality of openings 746 fluidly connected with the third internal passage 744, and a sixth plurality of openings 748 fluid connected with the third internal passage 744. The fifth and sixth openings 746 and 748 are located adjacent to the wall of the housing 701 to provide a gas flow path from the third stage 706 out of the reactor 700. In this case, an outlet plenum 750 is formed around the portion of the rotor 718 having the sixth openings 748. An outlet conduit 752 is fluidly coupled with the outlet plenum 750 to provide gas outlet.

In alternate configurations, the first and second walls 714 and 716 can be structured to end at a location adjacent to the rotor 718, but with a first gap between the rotor and the first wall 714 and a second gap between the second wall 716 and the rotor 718 to allow gas flow between the stages. In cases where mechanical support for the rotor 718 at either end of the reactor 700 is sufficient, and no intermediate mechanical support is needed, such structures can simplify the rotor 718.

The reactor 700 can be used to perform the same reaction in the three stages, or to perform different reactions in one or two of the stages. For example, the first stage 702 may perform a first reaction, the second stage 704 may perform a second reaction, and the third stage 706 may perform a third reaction. The disks of the three stages may be the same or different. Spacing of the disks in the three stages may be the same or different, and may be uniform in all the stages, non-uniform in all the stages, or a combination of uniform and non-uniform. In this case, the first stage 702 has six disks spaced uniformly with a first spacing, the second stage 704 has five disks spaced uniformly with a second spacing different from the first spacing, and the third stage 706 has 10 disks spaced uniformly with a third spacing similar to the first spacing. These disks may all be silicon or metal for thermal processing, or any of the disks may have a catalytic coating, catalytic components, and/or magnetic components. These disks are shown as uniformly solid disks, but any of the disks can be hollow or partially hollow as described above.

A reactor like the reactor 700 can have any reasonable number of stages. In some cases, a reactor like the reactor 700 can have a first plurality of stages driven by a first rotor and a first motor located at a first end of the reactor and a second plurality of stages driven by a second rotor and a second motor located at a second end of the reactor opposite from the first end. In such cases, the first motor and the second motor can be independently operated to provide target processing conditions in the first and second pluralities of stages. For example, the first motor can be operated to turn the rotating disks of the first plurality of stages at a first speed and the second motor can be operated to turn the rotating disks of the second plurality of stages at a second speed different from the first speed.

Collection spaces are provided for each of the stages of the reactor 700. A first collection space 760 is coupled to the first stage 702 to collect any non-gaseous products or byproducts of any of the reactions performed in the first stage. A second collection space 762 is coupled to the second stage 704, and a third collection space 764 is coupled to the third stage 706. The collection spaces can each collect any solids or liquids produced by interaction with the rotating disks of the respective stages.

A reactor like the reactor 700 can be used to remediate combustion exhaust, for example. The first stage 702 can be configured such that the first disks 708 have catalytic components to remove any residual hydrocarbon in the combustion exhaust by converting the hydrocarbon to carbon dioxide and water. Water, and any solids in the exhaust, can be collected in the first collection space 760. The resulting gas can flow to the second stage, where the second disks 710 can have catalytic components to remove nitrogen oxide gases. Any resulting solids or liquids can be captured in the second collection space 762. The third stage 706 can be operated to solidify carbon dioxide by providing cooling to the third disks 712. In this case, a cooling jacket 754 is provided to cool the walls of the third stage 750 to reduce a temperature of the interior of the third stage to a degasification temperature of carbon dioxide. In one case, the third stage can be cooled to freeze carbon dioxide. Gas containing carbon dioxide can contact the third disks 712 to create gas circulation and thermal transport within the third stage. Frozen carbon dioxide can drop into the third collection space 764. The third collection space can be maintained at a temperature that results in liquid carbon dioxide, such that the carbon dioxide removed from the combustion exhaust can be sent to appropriate disposition, such as subterranean sequestration or reforming-based chemicals manufacturing.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings but rather should be read as consistent with and as support for the following claims, which are to have their fullest and fairest scope.

We claim:

1. An apparatus, comprising:
a housing defining a cylindrical interior volume, the housing having at least one inlet and one gas outlet;
a plurality of disks disposed within the housing with uniform spacing, each disk having a central axis aligned with a central axis of the interior volume, and each disk having a condition that can be used to stimulate a chemical reaction in a gas proximate to a surface of the disk;
a rotor disposed along the central axis, and through a center, of at least some of the disks, the rotor extending outside the interior volume; and
a motor located outside the interior volume and coupled to the rotor to rotate the rotor and the disks.

2. The apparatus of claim 1, wherein the condition of at least some of the disks is a capacity to absorb energy from an energy unit and emit thermal energy into a gas proximate to a surface of the disk.

3. The apparatus of claim 1, wherein the rotor has a gas flow conduit in fluid communication with the interior of the housing.

4. The apparatus of claim 3, wherein the rotor is hollow.

5. The apparatus of claim 1, further comprising a heating element to heat the disks.

6. The apparatus of claim 5, wherein the heating element is an inductive heater.

7. The apparatus of claim 6, wherein each disk comprises a magnetic member.

8. The apparatus of claim 7, wherein a first portion of the disks is rotationally coupled to the rotor and a second portion of the disks is rotationally decoupled from the rotor, wherein each disk of the first portion is disposed between two disks of the second portion.

9. The apparatus of claim 1, further comprising a gas feed along a side of the housing.

10. The apparatus of claim 1, wherein each disk comprises a catalyst coating.

11. The apparatus of claim 4, further comprising a motor coupled to a first end of the rotor to turn the rotor, and further comprising a vacuum pump coupled to a second end of the rotor, opposite from the first end, and driven by the rotor to flow gas through the rotor.
